(19) United States
(12) Patent Application Publication
(10) Pub. No.: US 2004/0088987 A1
(43) Pub. Date: May 13, 2004

(54) Integrated gas compressor

(76) Inventor: Lars Malmrup, Lund (SE)

Correspondence Address: Steven S. Payne, Law Office of Steven S. Payne, 8027 ILIFF Drive, Dunn Loring, VA, 22027, US

(21) Appl. No.: 10/292,597

(22) Filed: Nov. 13, 2002

(51) Int. Cl. F02C 7/22

(52) U.S. Cl. 60/734

(57) ABSTRACT

A gas turbine unit which has a fuel gas compressor system for increasing the pressure of a fuel gas before entering a fuel system of the gas turbine unit is disclosed. The fuel gas compressor system comprises at least one compressor, gas inlet means for supplying the fuel gas to each compressor, and supply means for supplying the compressed fuel gas to the fuel system of the gas turbine unit. The fuel gas compressor system is placed inside a housing for the gas turbine unit.

### TECHNICAL FIELD

The present invention relates to a fuel gas compressor system for increasing the pressure of a fuel gas before entering a fuel system of a gas turbine unit. The fuel gas compressor system comprises at least one compressor, gas inlet means for supplying the fuel gas to each compressor, and supply means for supplying the compressed fuel gas to the fuel system of the gas turbine unit.

### DESCRIPTION OF THE PRIOR ART

Gas turbine units for combined small-scale power and heat generation are becoming more and more common. These kinds of compact plants are within the reach of a larger group of customers, such as offices, shops, hotels, hospitals, small industries, schools, and supermarkets, and for small-scale district heating installations.

The most common fuel for such systems is a gaseous fuel, e g natural gas, bio gas, flare gas, off gas, methane, propane or other man-made gases but could of course be any other fuel, e g diesel, gasoline or naphtha. The available fuel gas supply pressure is often lower than the required working pressure inside the combustion chamber of the gas turbine. The common solution solving this problem up to now has been to pressurise the supplied fuel gas by means of a separate compressor or supply it from a tank, which in turn is filled with a fuel gas that has been pressurised and supplied by a compressor, outside the high-pressure enclosure of the gas turbine, so that the fuel gas has a higher desired pressure before it enters the combustion chamber of the gas turbine. This pressurisation of the fuel gas could be done with a compressor of a centrifugal, axial, screw, or any other continuous flow type or of a positive displacement type.

Such a system for increasing a fuel gas pressure in a fuel system for a gas turbine is disclosed in U.S. Pat. No. 5,329,757. The system comprises a plurality of turbines and compressors, which are placed outside the gas turbine. The turbines are driven by pressurised gas or compressed air discharged from a high-pressure section of the gas turbine. Each turbine drives a corresponding compressor and a gaseous fuel is supplied to an inlet of the corresponding compressor. The compressed fuel is then cooled downstream of the compressors and delivered to the fuel system of the gas turbine.

These earlier compressor systems involve some disadvantages, e g they increase the required installation space and thereby cause additional investment costs; they require a number of safety valves; and they complicate the permit grant for the plant due to higher demands for installations with higher gas pressure compared to installations with lower pressure. There are also different demands in different countries making the enclosure of gas turbines more complex with associated higher costs.

### SUMMARY OF THE INVENTION

The main objects of the present invention are to simplify the construction of fuel gas compressor systems and facilitate the permit grant procedure for combined small-scale power and heat generation plants with gas turbine units, and to reduce their costs.

These objects are achieved for combined small-scale power and heat generation plants by placing the fuel gas compressor system inside a housing for the gas turbine unit.

Each compressor of the fuel gas compressor system can be driven by means of a hydraulic, air, gas or electrical drive. Each compressor of the fuel gas compressor system can be of a centrifugal, axial, scroll, screw or any other continuous flow type

By providing a gas turbine unit with a fuel gas compressor system according to the invention, the following advantages are achieved: a smaller installation area for the plant is required. Moreover, a grant for the plant is easier permitted due to the fact that this fuel gas compressor system requires no additional high-pressure enclosure of its own when placed inside the high-pressure housing or section of the gas turbine unit, thereby ensuring an enhanced security, reducing the number of regular and comprehensive inspections of the high-pressure sealing, and simplifying the maintenance of the gas turbine unit.

Furthermore, the investment costs and the maintenance costs are reduced.

### BRIEF DESCRIPTION OF THE DRAWINGS

The present invention will now be described in further detail, reference being made to the accompanying drawings, in which:

FIG. 1 is a side view showing a preferred embodiment of a fuel gas compressor system according to the invention,

FIG. 2 is a side view showing another embodiment of a fuel gas compressor system according to the invention, and

FIG. 3 is a side view showing yet another embodiment of a fuel gas compressor system according to the invention.

### DETAILED DESCRIPTION OF THE INVENTION

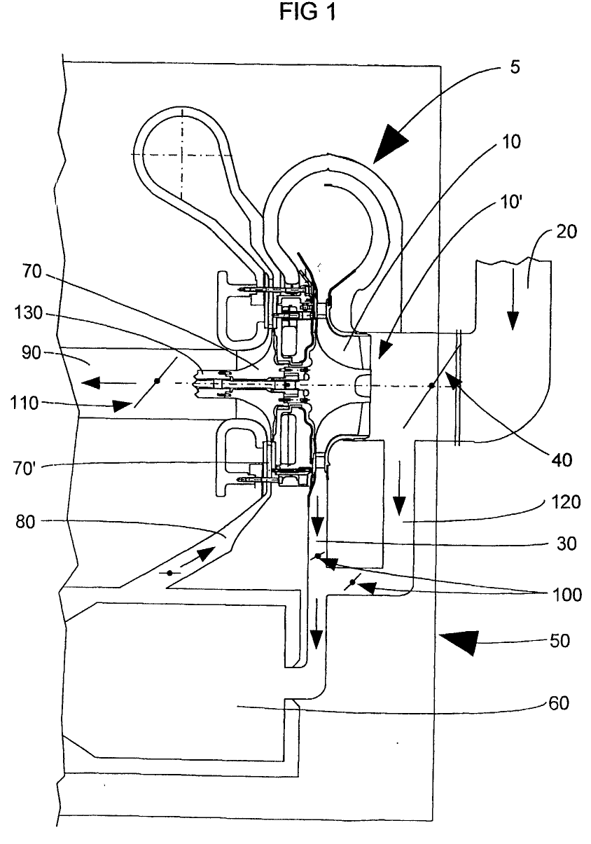

FIG. 1 shows a preferred embodiment of a fuel gas compressor system 5 mounted inside a housing 50 for a gas turbine unit, which in itself is not wholly shown. The housing encloses the high pressure section of the gas turbine unit. The fuel gas compressor system can even be placed physically inside a combustion chamber 60 of the gas turbine unit, or the fuel gas compressor system can be placed inside the high pressure section of the gas turbine unit and only have regulator means inside the combustion chamber, e g sensors for pressure, temperature, or mass flow. The fuel gas compressor system as shown in FIG. 1 has one compressor 10, gas inlet means 20 for supplying a fuel gas to a compressor inlet 10′ of the compressor, and supply means 30 for supplying the compressed fuel gas to the fuel system and the combustion chamber 60 of the gas turbine unit. Here, the fuel gas means a gaseous fuel supplied to the fuel system of the gas turbine unit, e g the combustion chamber 60, not the mixture of fuel and air for combustion inside the combustion chamber of the gas turbine unit. The fuel gas compressor system 5 also has one turbine 70 for driving the compressor 10, inlet means 80 for supplying a gas (as described below) to a turbine inlet 70′ of the turbine, and outlet means 90, which leads the expanded gas back to the gas turbine unit and/or to the surrounding. Furthermore, the fuel gas compressor system 5 has control means 40 for controlling the fuel gas supply through the compressor 10, and a conduit 120 adjacent the compressor inlet 10′ for leading fuel gas from the gas inlet means 20 into the supply means 30 so that a by-pass of fuel gas massflow to the combustion chamber 60 can be permitted, if required.

Optionally, the fuel gas compressor system 5 could also be equipped with control means 100 placed in the conduit of the supply means 30 and the conduit 120 for regulating the fuel gas supply into the combustion chamber 60 and/or with control means 110 placed in the conduit of the supply means 90 for regulating the exhaust gas after use for driving the turbine 70. The control means could be any kind of adjustable valves, e g throttle valves, shut-off valves or the like.

The compressor 10 and the turbine 70 are mounted on a common rotor shaft 130 supported by bearings (not shown). The rotor shaft is only partly shown for clarity reasons, and the bearings supporting the rotor shaft are also excluded for the same reasons.

Preferably, as shown in FIG. 1, the compressor 10 is of a single-stage centrifugal type and the turbine 70 is of a single-stage radial-flow type. Gas or air with a high pressure is bled from a high-pressure section, e g a compressor stage or a turbine stage (not shown) in the gas turbine unit, through the supply means 80 adjacent or downstream of the combustion chamber 60. It is important that the pressure of the bled gas or air is sufficient for driving the turbine 70, which drives the compressor 10 of the fuel gas compressor system 5 according to the invention.

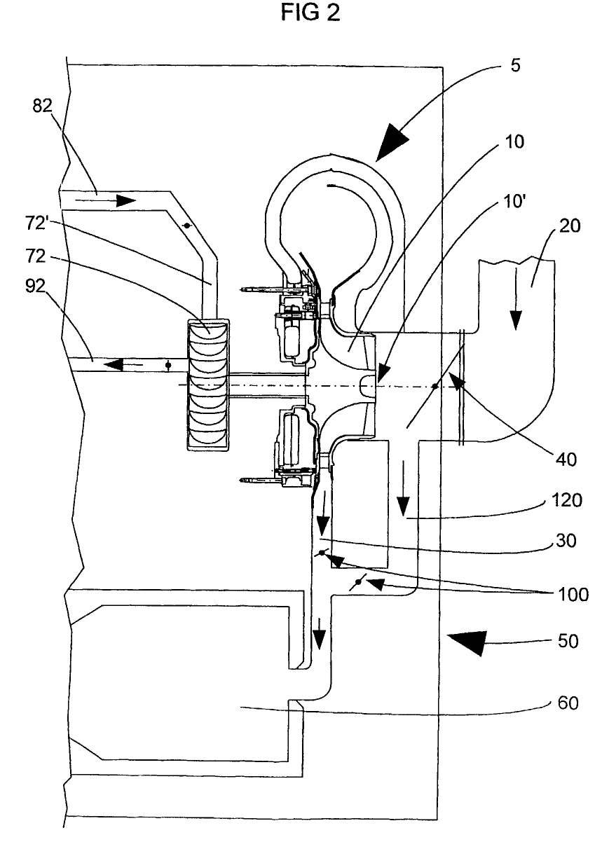

FIG. 2 illustrates another embodiment of a fuel gas compressor system 5 mounted inside a housing 50 for a gas turbine unit, which in itself is not wholly shown. The housing encloses the high pressure section of the gas turbine unit. The fuel gas compressor system 5 can even be placed inside a combustion chamber 60 of the gas turbine unit or the fuel gas compressor system can be placed inside the high pressure section of the gas turbine unit and only have regulator means inside the combustion chamber, e g sensors for pressure, temperature, or mass flow. The bearings supporting the rotating parts are excluded for clarity reasons. The fuel gas compressor system comprises the same components relating to the compressor side as in FIG. 1. The difference concerns the turbine 72, which drives the compressor 10. This turbine differs in that it is a hydraulically driven turbine instead of the gas or air driven turbine 70 in FIG. 1.

An oil flow is bled from a suitable high-pressure system (not shown) in the gas turbine unit, e g from the lubricant oil system, and supplied through supply means 82 extending from the high-pressure system into the turbine inlet 72′, as shown in FIG. 2. The oil supplied to the turbine 72 drives the turbine and is emptied from the turbine through the conduit of outlet means 92 leading back to the high-pressure system, whereby a closed oil circuit is created. The oil flow is provided by the existing oil pressure in the lubricant system or by a separate oil pump (not shown), which is driven by an existing drive, e g the rotating shaft of the gas turbine unit, or an external drive, e g an electric motor. Furthermore, the fuel gas compressor system 5 comprises a conduit 120 adjacent the compressor inlet 10′ for leading fuel gas from the gas inlet means 20 into the supply means 30, so that the massflow of fuel gas to the compressor 10 can be led, i e by-passed, directly to the combustion chamber 60. As is readily understood by a person skilled in the art any other medium, i e fluid or gas, could be used for driving the turbine 72, e g the turbine could be driven by water or steam with a high pressure.

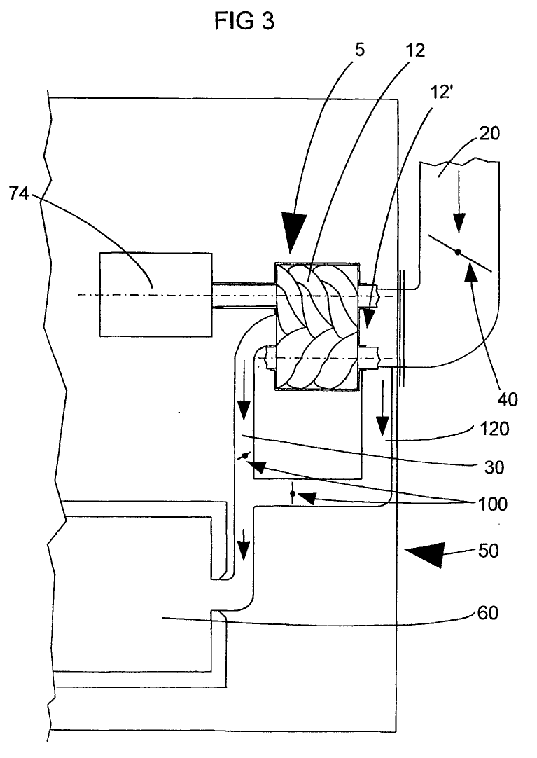

FIG. 3 shows yet another embodiment of a fuel gas compressor system mounted inside a housing 50 for a gas turbine unit, which in itself is not wholly shown as in FIGS. 1-2. The housing encloses the high pressure section of the gas turbine unit. This fuel gas compressor system 5 can also be placed inside a combustion chamber 60 of the gas turbine unit in the same manner as in FIGS. 1-2. The bearings supporting the rotating parts are also excluded for clarity reasons as in FIGS. 1 and 2. This embodiment of the fuel gas compressor system comprises a compressor 12 of a screw type, gas inlet means 20 for supplying the fuel gas to the compressor inlet 12′, and supply means 30 for supplying the compressed fuel gas to the fuel system and the combustion chamber 60 of the gas turbine unit. The fuel gas compressor system 5 also comprises a conduit 120 adjacent the compressor inlet 12′ for leading fuel gas from the gas inlet means 20 through the supply means 30 and into the combustion chamber 60, so that the same by-pass function as in FIGS. 1-2 can be achieved.

An electric motor 74 drives the compressor 12. Alternatively, the compressor could be driven of any other drive fulfilling the requirements, e g the gas or air driven turbine 70 of the first embodiment of the invention shown in FIG. 1, the oil driven turbine 72 of the second embodiment of the invention shown in FIG. 2, or a screw expander. If the gas turbine unit drives a high-speed electric generator, the power electronics controlling the generator could also be used for controlling the electric motor 74.

The automatic control of the three embodiments of the fuel gas compressor system 5 according to the invention could be done in the following manner: by means of by-passing the propellent gas driving the turbine 70 in FIG. 1, speed control of the electrical motor 74 in FIG. 3, or by using adjustable geometry at the turbine 70 in FIG. 1 or at the compressor 10 or 12 in FIGS. 1-3. This control could also be done by using any other technology fulfilling the demands of regulation.

During the starting phase of the gas turbine unit compressed air from a separate tank or a compressor can be used, until the pressure of the air or gas bled from the high-pressure section of the gas turbine unit and used for driving the fuel gas compressor system 5 has become high enough.

The fuel gas compressor system 5 according to the invention could also have more than one compressor 10 or 12, i e more than one compressor stage, to achieve a sufficiently high pressure for the fuel gas when supplied to the combustion chamber 60. The fuel gas compressor system could also have more than one turbine 70 or 72, i e more than one turbine stage, for driving each compressor.

1. A fuel gas compressor system (5) for increasing the pressure of a fuel gas before entering a fuel system of a gas turbine unit, the fuel gas compressor system comprising at least one compressor (10), gas inlet means (20) for supplying the fuel gas to each compressor, and supply means (30) for supplying the compressed fuel gas to the fuel system of the gas turbine unit,
characterized in that the fuel gas compressor system (5) is placed inside a housing (50) for the gas turbine unit.

2. A fuel gas compressor system according to claim 1, wherein each compressor (10, 12) of the fuel gas compressor system (5) is driven by means of a hydraulic, air, gas or electric drive.

3. A fuel gas compressor system according to claim 1, wherein each compressor (10, 12) of the fuel gas compressor system (5) is of a centrifugal, axial, scroll, screw or any other continuous flow type.

4. A fuel gas compressor system according to claim 3, wherein each compressor (10, 12) of the fuel gas compressor system (5) is driven by a corresponding turbine (70, 72), which is hydraulic, air or gas driven by means of oil, compressed air or gas bled from a high-pressure section of the gas turbine unit.

5. A fuel gas compressor system according to claim 3, wherein each compressor (10, 12) of the fuel gas compressor system (5) is driven by an electric motor (74).

6. A fuel gas compressor system according to claim 3, wherein each compressor (10, 12) of the fuel gas compressor system (5) is of a screw type and is driven by a corresponding screw expander of the fuel gas compressor system, which is hydraulic, air or gas driven by means of oil, compressed air or gas bled from a high-pressure section of the gas turbine unit.

7. A fuel gas compressor system according to claim 3, wherein each compressor (10, 12) is physically connected to a rotating shaft of the gas turbine unit and driven by said shaft.

8. A fuel gas compressor system according to claim 1, wherein the housing (50) for the gas turbine unit encloses a high-pressure section of the gas turbine unit.
